(19) United States
(12) Patent Application Publication
(10) Pub. No.: US 2016/0365999 A1
(43) Pub. Date: Dec. 15, 2016

(54) METHOD AND APPARATUS FOR CANCELLING IMPULSE NOISE IN DSL SYSTEMS

(71) Applicant: Ikanos Communications, Inc., Fremont, CA (US)

(72) Inventors: Pravesh Biyani, Minneapolis, MN (US); S. M. Zafaruddin, Bangalore (IN); Laurent Pierrugues, Fort Lee, NJ (US); Laurent Francis Alloin, Monmouth Beach, NJ (US)

(21) Appl. No.: 15/207,211

(22) Filed: Jul. 11, 2016

Related U.S. Application Data
(63) Continuation of application No. 14/058,112, filed on Oct. 18, 2013, now abandoned.

(30) Foreign Application Priority Data
Oct. 18, 2012 (IN) 4356/CHE/2012

(51) Int. Cl. H04L 27/26; H04B 1/10; H04M 3/18

(52) U.S. Cl. CPC H04L 27/265; H04M 3/18; H04B 1/1036; H04L 2012/6478

(57) ABSTRACT

The present invention generally relates to an impulse noise canceller for DSL systems. According to certain aspects, embodiments of the invention provide a dual sensor receiver to deal with the impulse noise effectively. The second sensor can be incorporated by either a common mode or unused differential port. Alternatively a power line sensor can also act as a sensor. According to certain additional aspects, embodiments of the invention provide various alternative implementations of an impulse noise canceller within a DSL receiver. According to still further aspects, embodiments of the invention provide methods for selectively training an impulse noise canceller in the various implementations.

### CROSS REFERENCES

The present Application for Patent is a continuation of U.S. patent application Ser. No. 14/058,112 by Biyani et al., entitled “Method and Apparatus for Cancelling Impulse Noise in DSL Systems,” filed Oct. 18, 2013; which claims priority to India Provisional Application No. 4356/CHE/2012 by Biyani et al., entitled “Impulse Noise Canceller,” filed Oct. 18, 2012; each of which is assigned to the assignee hereof and expressly incorporated by reference herein.

### BACKGROUND

### Field of the Disclosure

The present invention relates generally to data communications, and more particularly to an impulse noise canceller for DSL systems.

### Description of Related Art

Digital subscriber lines (DSL) constitute a promising broad access technology for millions of subscribers around the world. This technology provides high speed data transmissions over twisted pairs by exploiting inherent high bandwidth of copper wires. Although the technology offers low cost alternatives to fibre transmissions, it suffers from various impairments. These impairments limit the data rate and quality of broadband service significantly, and need to be dealt with effectively. The major impairments can be divided into two categories: stationary (self and alien crosstalk, radio ingress etc.) and non-stationary i.e. impulse noise. Although vectored transmission is capable of deriving DSL lines crosstalk-free, the presence of impulse noise still presents a major problem for good broadband experience.

A challenge to tackle impulse noise lies in its properties of being high power with short duration, making its cancellation very difficult. For example, it is not possible to train the canceller for such a short duration.

The common sources of such impulse noise at the customer premises are powerline communication systems such as HP AV, and household appliances like washing machines, televisions, etc. The Impulse Noise (IN) can be further classified into coming from Repetitive (REIN) and Non-Repetitive noise sources. Repetitive sources are those that repeat themselves and many of them are even periodic. There are some impulse noise sources that are non-repetitive but occur for a longer duration.

Coding techniques are generally applied to mitigate the effect of impulse noise. However, coding techniques (e.g. combined RS coding and interleaving etc.) introduce long delays that are not desirable for many critical applications. A DSL system with a combination of RS coding and interleaving requires an interleaving/deinterleaving depth of 8 ms to achieve impulse noise protection (INP) of two DMT symbols, and such a long delay can be an annoying factor for some applications such as live video transmission. Retransmission techniques have been considered to replace interleaving but retransmission techniques also incur latency. However, further improvements are needed.

### SUMMARY

The present invention generally relates to an impulse noise canceller for DSL systems. According to certain aspects, embodiments of the invention provide a dual sensor receiver to deal with the impulse noise effectively. The second sensor can be incorporated by either a common mode or unused differential port. Alternatively a power line sensor can also act as a sensor. According to certain additional aspects, embodiments of the invention provide various alternative implementations of an impulse noise canceller within a DSL receiver. According to still further aspects, embodiments of the invention provide methods for selectively training an impulse noise canceller in the various implementations.

In furtherance of these and other aspects, an apparatus according to embodiments of the invention includes a receiver coupled to receive a data signal of a wire line communication system; a sensor that is coupled to not receive the data signal and is configured to produce a sensor signal that represents noise affecting the received data signal; and an impulse noise canceller that cancels impulse noise affecting the received data signal based on the sensor signal.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1a is a diagram illustrating impulse noise impacting a DM sensor and a secondary sensor according to embodiments of the invention;

FIGS. 1b, 1c, 1d illustrate embodiments of the dual sensor receiver with a second sensor, as a CM sensor (FIG. 1b), DM sensor on an unused pair (FIG. 1c), a Power Line sensor (FIG. 1d).

FIG. 2 is a block diagram illustrating an example DM transmission and reception chain;

FIG. 3 is a block diagram illustrating an example dual DM and CM sensor receiver according to embodiments of the invention;

FIG. 4 a block diagram illustrating one example noise canceller scheme according to embodiments of the invention;

FIG. 5 is a block diagram illustrating an example joint receiver scheme according to embodiments of the invention;

FIG. 6 is a block diagram further illustrating an example Impulse Noise canceller scheme according to embodiments of the invention;

FIG. 7 is a graph illustrating the convergence time of the MOE/FFT based MMSE training of the canceller;

FIG. 8 is a graph illustrating the convergence time for a MMSE based on slicer error canceller approach;

FIG. 9 illustrates an example of how displacement of the CM sensor output at a given tone q due to impulse noise projects into the DM signal;

FIG. 10 illustrates how to implement a selective training scheme in the event of an impulse noise such as that shown in FIG. 9;

FIG. 11 is a flowchart illustrating an example method for selectively training an MMSE based impulse canceller;

FIG. 12 illustrates another example of how displacement of the CM sensor output at a given tone q due to impulse noise projects into the DM signal;

FIG. 13 illustrates how to implement a selective training scheme in the event of impulse noise such as that shown in FIG. 12;

FIG. 14 is a flowchart illustrating an example method for selectively training an MOE based impulse canceller;

FIG. 15 illustrates yet another example of how displacement of the CM sensor output at a given tone q due to impulse noise projects into the DM signal;

FIG. 16 is a flowchart illustrating another example method for selectively training an MOE based impulse canceller;

FIG. 17 is a flowchart illustrating an example hierarchical method for selectively training both an MOE based and MMSE impulse canceller; and

FIG. 18 is a flowchart illustrating another example hierarchical method for selectively training an impulse canceller.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain general aspects, embodiments of the invention provide a dual sensor receiver for a CPE to effectively deal with impulse noise. The second sensor provides a reference to estimate the source of impulse noise and cancel its projection onto the main differential mode (DM) receiver line and thus into the primary DM sensor.

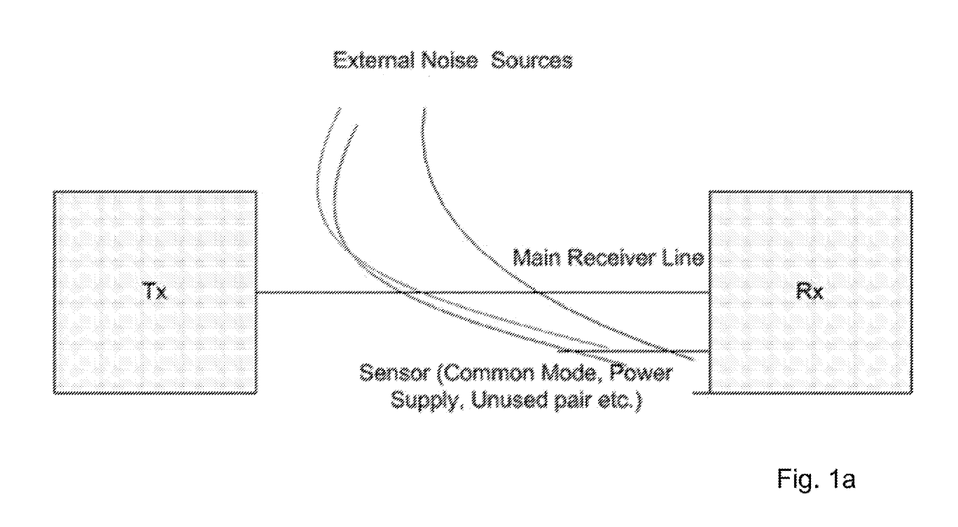

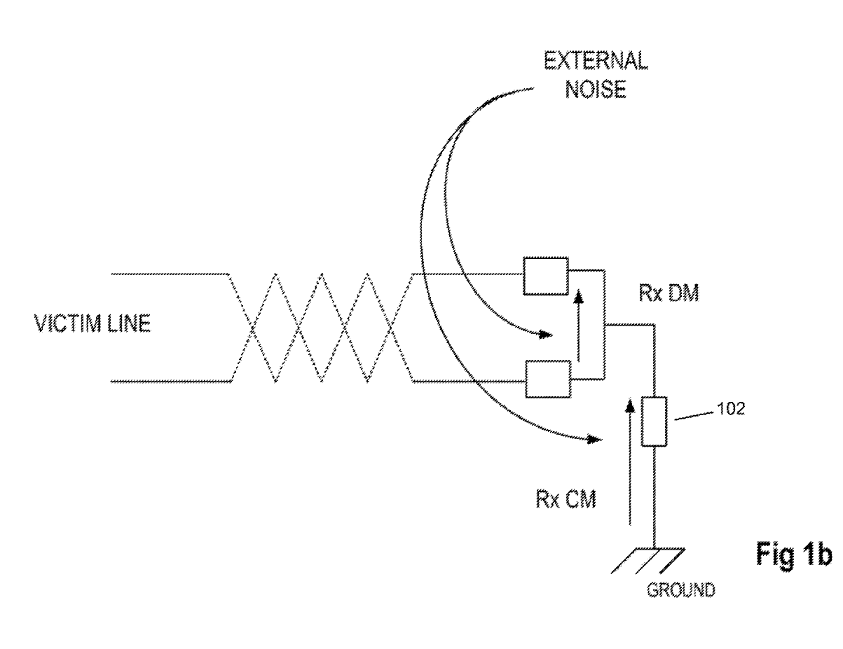

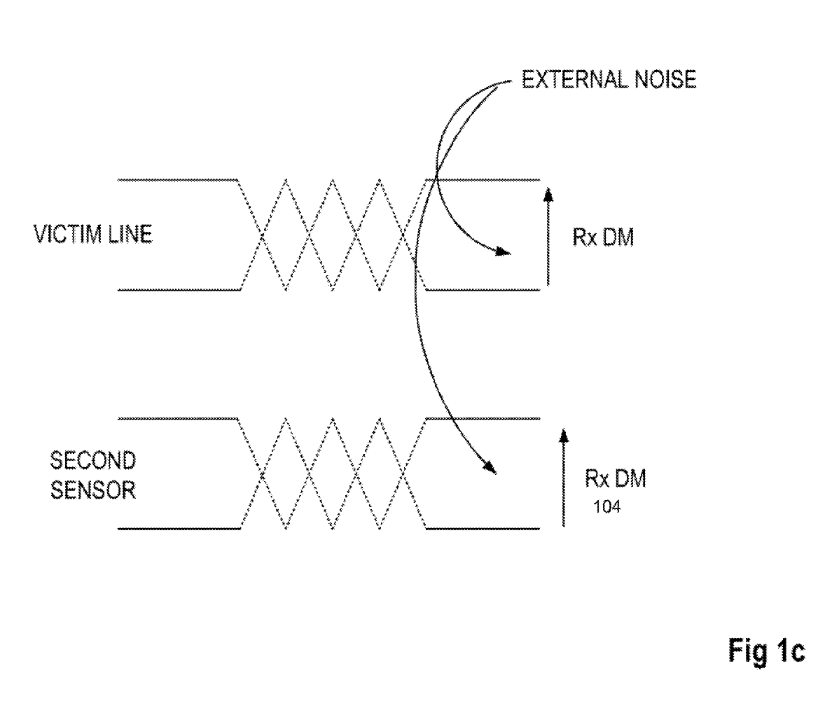

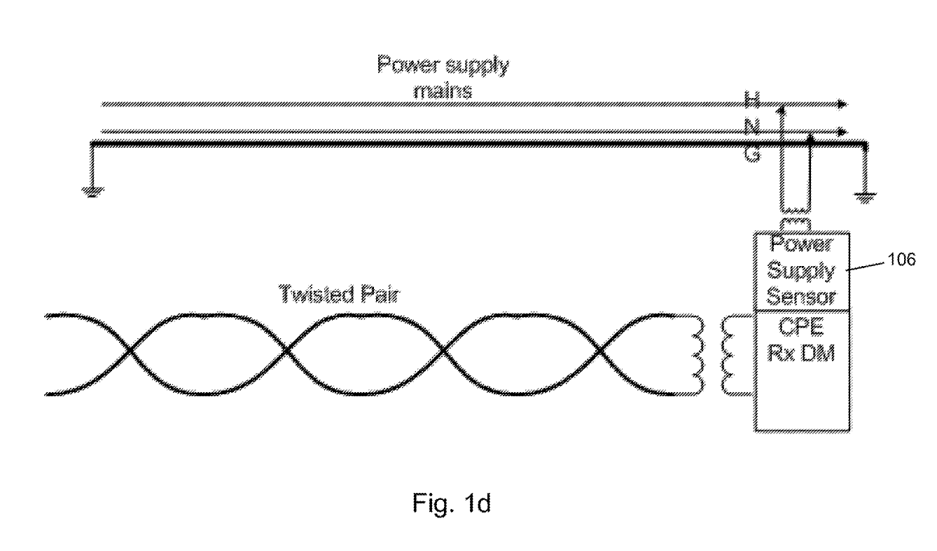

According to further aspects, the present inventors recognize that one problem of cancelling an external single source of noise when multiple projections of it are received on more than one sensor is a classical noise cancellation problem. This is illustrated in FIG. 1a, wherein in a DSL Downstream transmission scenario, the external noise sources couple to the main receiver line and to a secondary sensor. FIG. 1a depicts a Central Office (CO) transmitter (Tx) coupled to Customer Premises Equipment (CPE) receiver (Rx) through a channel.

There are various ways of implementing the second sensor according to the invention. For example, the second sensor can be incorporated by a common mode (CM) sensor 102 such as that shown in FIG. 1b. The second sensor can alternatively be another DM sensor 104, which can be a sensor coupled to an unused twisted pair, for example, such as that shown in FIG. 1c. Alternatively, the second sensor can be a power line sensor 106, coupled to a home power line for example, as illustrated in FIG. 1d.

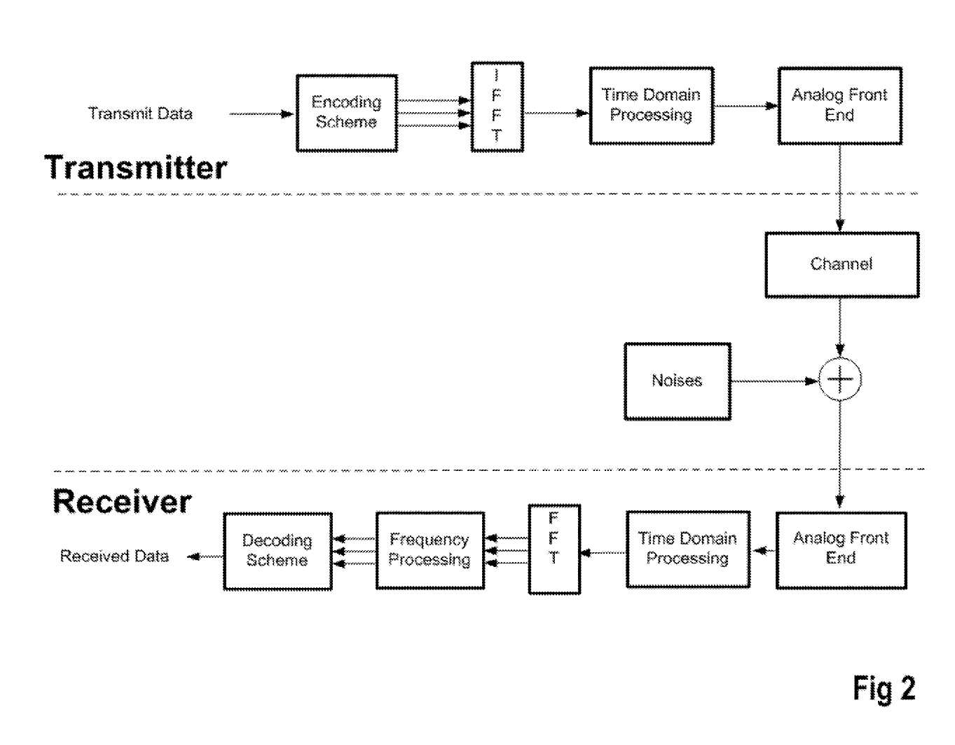

A schematic diagram is shown of a single line DSL transmitter and receiver is depicted on FIG. 2. At the transmitter, the transmit data is encoded and mapped into a frequency domain multicarrier symbol which is converted to time domain before being sent to the channel through an analog front end. While propagating through the channel, the DSL signal picks up unwanted noises such as impulse noise, before being processed by the receiver at the other end of the channel. In a multicarrier differential mode (DM) receiver such as that shown in FIG. 2, processing consists of a time domain processing followed by an FFT based demodulation process and a per tone frequency domain processing that presents the useful demodulated signal carried by each carrier to a decoder for final data decoding.

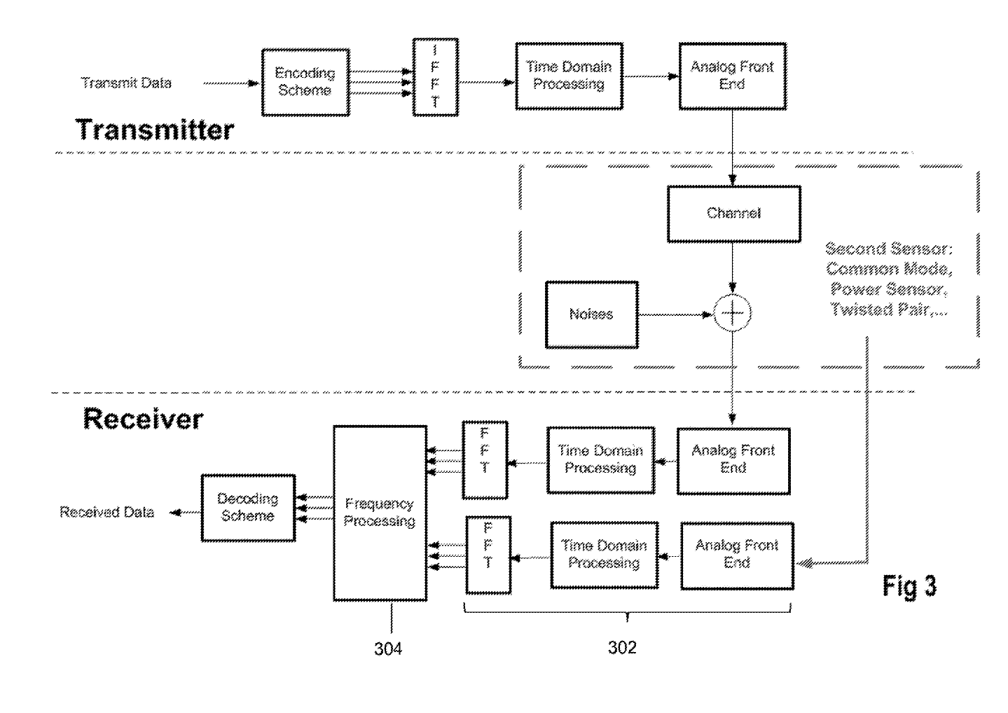

FIG. 3 depicts an example embodiment of the invention which includes the addition of a secondary sensor in the CPE receiver. As shown in FIG. 3, the signal from the secondary sensor is provided to a separate processing path 302, which includes an analog front end to sample the signal, time domain processing to process the time domain samples, and a FFT to convert them to frequency domain, where they are processed jointly on a per tone basis with the per tone frequency domain information received on the Differential Mode sensor. The joint frequency domain process 304 has the objective of improving the reliability of the useful demodulated signal carried by each carrier that is presented to the decoder for final data decoding.

In the foregoing descriptions, the second sensor is generally associated with a CM sensor. However, as mentioned above, the reference to a CM sensor is just one possible embodiment, and those skilled in the art will recognize how to implement the invention using other possible second sensors after being taught by the disclosure.

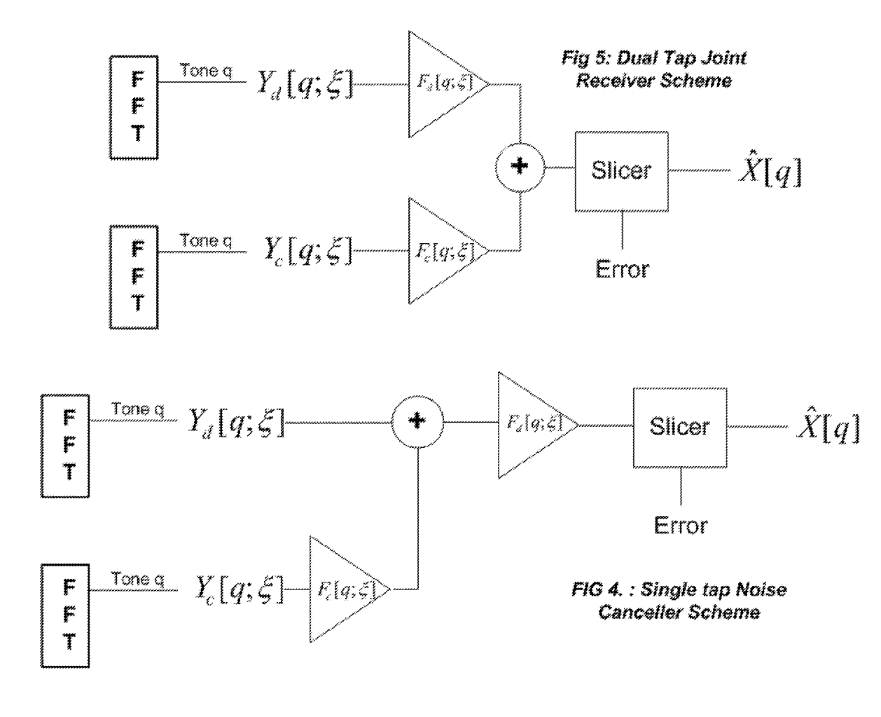

FIG. 4 depicts a possible embodiment of the joint frequency domain processing 304, which is referred to as a single tap noise canceller scheme. In FIG. 4, the per tone frequency domain information on the primary DM path and its corresponding per tone frequency domain information on the secondary CM path are combined after a processing by filter Fc, referred to as the noise canceller. The combined output is then processed by a differential mode filter Fd, referred to as a Frequency Domain Equalizer (FEQ), that is applied independently of the derivation of Fc in order to yield an estimate of the transmit symbol x. The estimate of the transmit symbol x is sliced by a slicer to yield a decision along with a residual error.

FIG. 5 depicts another possible embodiment of the joint frequency domain processing 304, which is referred to as dual tap joint receiver scheme. In FIG. 5, the per tone frequency domain information on the primary DM path and its corresponding per tone frequency domain information on the secondary CM path are combined after processing respectively by filter Fd and by filter Fc. The combined output yields an estimate of the transmit symbol x. The estimate of the transmit symbol x is sliced by a slicer to yield a decision along with a residual error. In FIG. 5, filters Fd and Fc act together to jointly implement the Noise Canceller and Frequency Domain Equalizer.

Minimizing the mean square error (MMSE) in an optimization process to derive the canceller coefficients is the most natural way to handle a noise cancellation problem. An MMSE formulation, assuming the accurate knowledge of the error signal and in the presence of the additive Gaussian noise on both sensors, leads to the best possible performance (the Cramer Rao lower bound). It is also one of the “quickest” ways to derive the canceller coefficients. However, estimating the canceller coefficients is complicated by the presence of useful signal on one or both sensors. One possible embodiment of the optimization process consists of minimizing the residual error after slicing and will be referred to as MMSE solution based on the slicer error. The exactness of the residual error term is highly dependent on the correct detection of the transmit symbol. Ensuring the reliability of the residual error term for the optimization process is not always possible as the power of the impulse noise is high enough to make probability of incorrect detection also very high.

In the absence of an accurate and reliable sliced error term for training the canceller, formulating the noise canceller estimation process as a minimum output energy (MOE) problem is another option. This second possible embodiment of the optimization process consists of minimizing the energy of the canceller combined output given a fixed useful signal power. In one system model according to the invention, it is also referred to as MMSE solution based on FFT output data. One drawback of the MOE formulation is its slow speed of convergence. In many practical scenarios in VDSL, MOE would take a very large number of symbols to converge in order to account for the relatively higher power of the DSL useful signal compared to the power of the impulse noise. However, in many low SNR cases where the power of the impulse noise is high, the MOE approach, which processes directly FFT output data of the CM and DM sensors without requiring access to the sliced error, can be very useful. In yet another embodiment, the MOE approach is utilized as an initialization step to help derive more reliably the MMSE optimization based on the slicer error described above.

In any event, in both MMSE and MOE optimization approaches, a fundamental problem in determining the IN canceller is the training of its coefficients. For the MMSE based optimization based on the slicer error, since the impulse does not necessarily occur during known sync symbols or during a quiet line noise (QLN) period, when no DSL useful signal is being transmitted on the line, it is rather difficult to train the canceller during its occurrence due to the unreliability of the slicer error term. To train the canceller, one needs a reliable estimate of the transmitted symbol, which might not be easily available, due to the relatively higher power of the impulse over the background noise. On the contrary, for MOE or MMSE FFT based output optimization, the problem of fast and reliable training arises due to the relatively larger power of the useful signal with respect to that of the impulse noise. The larger power of the modulated useful signal over the power of the correlated impulse noise in the FFT output data slows down the optimization process and increases its time to convergence.

In embodiments of the invention, this challenge is met by using what is called selective training. This is done using jointly the instantaneous symbol information at the CM and the DM. Since the cancellation is performed per frequency tone in the VDSL systems, the so-called selective training is also done per-tone. However, one may note that this technique can be done for multiple tones at a time and that it can also be used in time domain processing.

A system model that relates to an example embodiment of a single tap per-tone noise canceller that can be applied to the received CM signal, as illustrated on FIG. 4, will now be described. The system model is described first, including describing the notations. Let y_{d}[q] and y_{c}[q] be the received signal in DM and CM respectively, on tone q. Let h_{d}[q] be the direct channel coefficient for the DM. Let x[q] be the transmit symbol in tone q. Let z denote the impulse noise source. The impulse noise channel coefficients for a given source on DM and CM lines be given by a₁[q] and a₂[q] respectively. Finally, let v₁ and v₂ be the background noise in DM and CM respectively. The tone wise system model for the DS is given by the following equations.

y_{d}[q]=h_{d}[q]x[q]+v₁+a₁[q]z (1)

y_{c}[q]=v₂+a₂[q]z (2)

The SNR in the absence of the impulse noise source in the DM is given by

$${SNR}_{awgn = \frac{\vert {h}_{d} {σ}_{x}^{2} \vert}{{σ}_{v 1}^{2}}}$$

where σₓ² is the average signal transmit energy and σᵥ₁² is the variance of the AWGN in the DM.

Note that when only the background noise v₁ is present, the BER after slicing the received signal y_{d}[q] is 10⁻⁷. The tone index q can be ignored in subsequent analysis, as the method suggested is identical for all the tones. Note that the noise samples v₁ and v₂ might also contain alien noises and other crosstalk sources.

Impulse Noise Cancellation

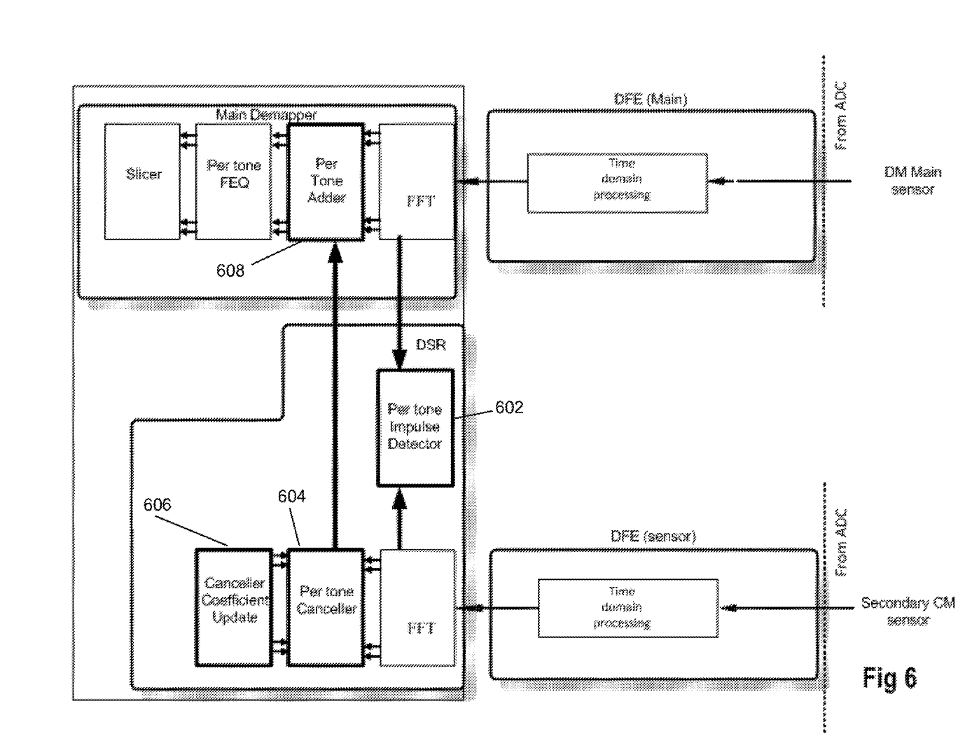

As illustrated in FIG. 6, an impulse noise cancellation (INC) scheme according to embodiments of the invention is performed in three stages, embodied by the four blocks 602, 604, 606 and 608. The first stage is the impulse detection stage, of which the main aim is to flag that a particular DMT symbol is impacted by an impulse. This process is embodied by the Per Tone Impulse Detector block 602. In the second stage, the per-tone impulse canceller is trained (or updated) using the knowledge available from the current impulse affected sample. This process is embodied by the Canceller Coefficient Update block 606. In the third stage, the per-tone linear canceller is applied to the CM signal and the result is added to the DM demapper. This process is embodied by the Per Tone Canceller block 604 and the per Tone Adder block 608.

It should be noted that the following discussion does not focus on the impulse detection. Rather, it is assumed that the impulse has been correctly detected. Example methods for detecting impulse noise that can be used in the present invention include those described in co-pending application Ser. No. 14/054,552, the contents of which are incorporated herein by reference in their entirety.

It should be further noted that those skilled in the art will be able to adapt a conventional DSL receiver such as that shown in FIG. 2 with the functionality of the blocks 602, 604, 606, 608 shown in FIG. 6 after being taught by the present disclosure.

FFT output based MMSE Estimation of the Canceller

Since the impulse noise is present in both the primary DM and secondary CM signals, the two signals can be linearly combined to effectively mitigate the noise. Moreover, since the additive noise is Gaussian in nature, an MMSE canceller will result in an optimum performance. Let the linear canceller be β. Thus, the resulting DM signal is given by:

y_{d′}u_{d}+βy_{c} (4)

Where y_{d′}, is followed by an FEQ scaling and a slicing operation, as illustrated in FIG. 4.

A solution to estimating the canceller is given by the Wiener filter. The Wiener estimator for β (or Fc) is based on the following optimization problem:

arg_min_{β}E{|y_{d′}|²} (5)

The idea is to minimize the average total output energy on the linear combination. The total output energy consists of useful signal and the residual noise signals. Since the average energy of the useful transmitted DSL signal is constant, this formulation will ensure minimum residual noise by selection of the appropriate β. On solving (5) the following estimate of β is obtained:

$$\hat{β} = - \frac{E \{ {y}_{d} {y}_{c}^{*} \}}{E \{ {\vert {y}_{c} \vert}^{2} \}} \qquad ( 6 )$$

Where * denotes the conjugate operation.

Putting expressions of y_{c} and y_{d} in (6) gives:

$$\hat{β} = - \frac{{α}_{1}}{{α}_{2}} ( \frac{E \{ {\vert z \vert}^{2} \} )}{E \{ {\vert z \vert}^{2} \} + {σ}_{v 2}^{2}} ) = - \frac{{α}_{1}}{{α}_{2}} η \qquad ( 7 )$$

Since the impulse noise power (when present) is generally higher than the background noise, η is approximately 1. The Wiener estimate is obtained directly by the processing the received symbols y_{d} and y_{c}. While this is the strength of this simple solution, unfortunately, to compute the expectations in (6), one needs a large number of symbols (of the order 10⁵). This is because of the averaging required for evaluating E{y_{d}y_{c}*}, where it is necessary to average a high energy quantity to zero in the presence of the low energy correlated impulse noise. This constitutes the limit of the FFT output based MMSE Estimation process to derive the coefficients of the canceller: estimating the covariance matrix in (6) is a difficult process as the impulse signal z that is assumed to be the correlated signal across DM and CM is of much lower variance than the useful DSL signal on the DM sensor. Also, the problem is exacerbated by the fact that the useful signal is modulated and the instantaneous power of the useful signal x can vary greatly for large constellation size. For example, a 14 bit QAM constellation presents an instantaneous power that vary by as much as 42 dB (ratio of the power of the innermost constellation point to the power of the outermost constellation point). The modulation of the useful signal of which the instantaneous power varies by a large amount and with an amplitude that may or may not exceed the instantaneous power of the impulse leads to the fact that a greater amount of symbols is required for an accurate estimate of the cross-correlation term, than if the useful signal had not been modulated or had been modulated with a constant power (phase modulation). The benefit of the MOE, however, is that it does not rely on the slicer error, which may be unreliable when subjected to high impulse noise. Plus, MMSE estimate based on the slicer error and MOE based on the FFT output have been shown to converge towards the same solution for zero-mean useful signal x.

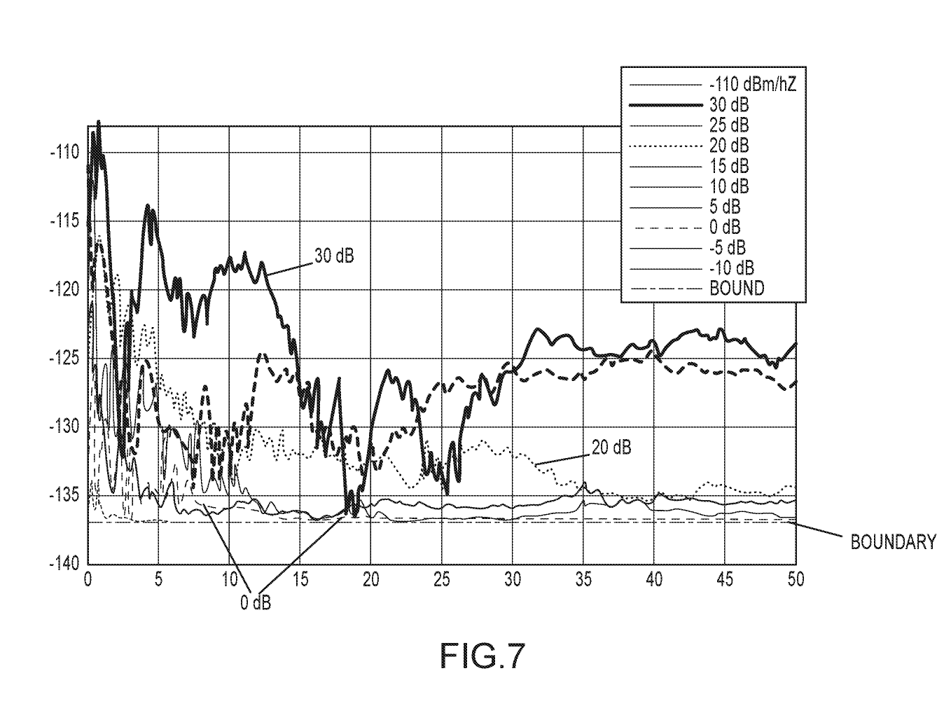

For illustration, simulation was carried out to determine the time of convergence to the bound with various power of useful signal to interference ratio, for a modulated signal that is modulated as a 4 QAM signal with constant power. The MOE estimator is computed according to (6) as a block solution over an increasing number of symbols to evaluate the performance against the bound. The results illustrate the impact of the fact that the useful signal is being modulated. It is representative of the scenario in which the useful signal is modulated with a constant power: a 4 QAM signal. The conditions for the simulation are summarized below: the useful signal power at the receiver varies from −80 dBm/Hz to −120 dBm/Hz, with a background noise at −140 dBm/Hz. With an impulse noise level constant at −110 dBm/Hz, the simulation scans the range of Useful Signal Power to Interference Power Ratio (UIR) from 30 dB down to −10 dB. As illustrated in the results presented in FIG. 7 and Table 1 below, depending on the UIR, the MOE optimization converges to a solution which can be close to the bound or away from it. The lower the UIR (−10 dB), the faster the convergence. This is expected as the modulation of the useful signal “impedes” the process of the correlation of the underlying CM noise when UIR is positive. As UIR becomes negative, the level of the modulated useful signal is no longer dominant. The correlation is as effective as in absence of a modulated useful signal. Table 1 shows that at low UIR (<10 dB) the MOE converges to the bound within a few hundred symbols. Above 10 dB of UIR, MOE does not converge within a reasonable amount of symbols in the simulation. To circumvent this problem of slow convergence, embodiments of the invention employ a selective training approach for the MOE training, as described in more detail below.

TABLE 1

| UIR (dB) | Symbols | Gain (dB) | Loss from bound (dB) |
|---|---|---|---|
| 30 | 30k | 13 | 14 |
| 25 | 25k | 17 | 10 |
| 20 | 12k | 20 | 7 |
| 15 | 5k | 20 | 7 |
| 15 | 14k | 27 | 0 |
| 10 | 4k | 24 | 3 |
| 5 | 800 | 25 | 2 |
| 0 | 600 | 21 | 6 |
| −5 | 160 | 25 | 2 |
| −10 | 500 | 27 | 0 |

Slicer error based MMSE Estimation of the Canceller

As an alternative to the MOE training based on FFT output one can as well use the standard MMSE formulation using the slicer error samples to solve the problem of estimation of the canceller. In this scenario the MMSE canceller linear coefficient β can be estimated to yield an estimate of x using the following equation:

$$β = \frac{E \{ ( {y}_{d} - hx ) {y}_{c}^{*} \}}{E \{ {\vert {y}_{c} \vert}^{2} \}} \qquad ( 8 )$$

The estimate of β in (8) relies on the information of the transmit symbol x. Since, the impulse might not occur during the quiet line period (where x is simply 0) or during the transmission of the sync symbol which is known at the receiver, one may not have this information readily available. The canceller thus needs to be trained in data mode on a sliced error derived from a faithful estimate of the transmitted symbol. However, during data mode, due to the high power of the impulse, the bit-error rate (BER) may be relatively high and it may therefore yield decoding errors when simply slicing the equalized symbol y′_{d} to the nearest constellation point. The incorrect slicing leads to unreliable error samples for the training of the canceller, which makes the estimate in (8) diverges from the optimum solution.

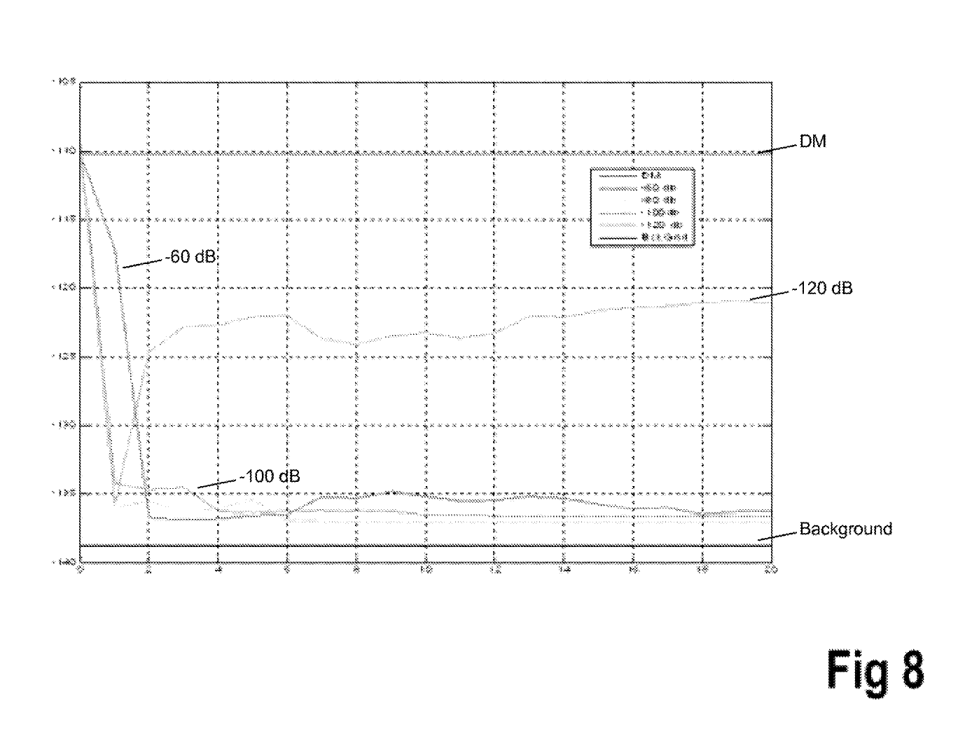

Simulation was carried out to determine the time of convergence to the bound of the slicer error based MMSE estimation for various power of useful signal to interference ratio and for a modulated signal that is modulated as a 4-QAM signal with constant power. The conditions for the simulation are summarized below: the useful signal power at the receiver varies from −60 dBm/Hz to −120 dBm/Hz, with a background noise at −140 dBm/Hz. With an impulse noise level constant at −110 dBm/Hz, the simulation scans the range of Useful Signal Power to Interference Power Ratio (UIR) from 50 dB down to −10 dB. FIG. 8 shows that for a 4-QAM modulated signal, MMSE based on slicer error will only perform reasonably well for positive UIR. Above 10 dB, MMSE training based on slicer error requires a sufficiently low BER to be effective. As expected at −10 dB of UIR, the MMSE estimator diverges. A value of 10 dB UIR is probably the threshold for a 4-QAM signal at which an acceptable BER can still be achieved to allow training of the MMSE solution based on the slicer error. To circumvent this problem, embodiments of the invention employ a selective training approach to the MMSE training. The following discusses the selective training of the INC. Also described later, for faster convergence of the selective algorithm, a good initialization is required.

Selective Training based on UINR for slicer error based MMSE estimation:

The estimator described in the equation (8) requires the knowledge of x which is not available in data mode. The basic idea is to train the impulse canceller only during those instances where the probability of correct detection of x is sufficiently high. This is possible since the per-tone impulse is assumed to be random. In order words, embodiments of the invention train the canceller when the instantaneous total noise in the DM does not give detection error on slicing. It is therefore necessary to establish criteria for determining that a certain instance of impulse permits training. To arrive at the criteria, a simple observation is made that the absolute total noise on the DM should be less than the half of the minimum distance between the adjacent points of the transmit constellation with a very high probability. This minimum distance is defined as dₘᵢₙ. Thus, using (1), the probability of the event of correct detection can be written as:

$$p ( \vert {v}_{1} + {α}_{1} z \vert ) < \frac{{d}_{min}}{2} = 1 - {p}_{e} \qquad ( 9 )$$

where, 1−pₑ is the probability of the above event. Using a similar argument and the definition of SNR in (9) that, in the absence of impulse noise,

$$p ( \vert {v}_{1} \vert > \frac{{d}_{min}}{2} ) > {10}^{- 7} .$$

Now, consider the event of no detection error described in (9). The total noise in DM in the instance of this event is denoted by \tilde{v}₁+α₁\tilde{z}. Now if pₑ=10⁻⁷ and if E{\tilde{v}₁+α₁\tilde{z}}2}=0, the following can be deduced:

E{|\tilde{v}₁+α₁\tilde{z}|²}=σᵥ₁² (10)

A quantity called Useful Signal Power to Instantaneous Noise Power ratio represented by (UINR) is now defined and given by the following expression

$$UINR = \frac{{\vert {h}_{d} \vert}^{2} {σ}_{x}^{2}}{( {\vert {v}_{1} + {α}_{1} z \vert}^{2}} \qquad ( 11 )$$

This is the ratio of the average power of the transmitted constellation and of the instantaneous power of the true error affecting a particular constellation point.

Consider the random variable,

$$\frac{1}{UINR} = \frac{( {\vert {v}_{1} + {α}_{1} z \vert}^{2}}{{\vert {h}_{d} \vert}^{2} {σ}_{x}^{2}} .$$

### Now if

$$\frac{1}{UINR} \leq \frac{1}{{SNR}_{awgn}}$$

it implies that

$$E \{ \frac{1}{UINR} \} \leq \frac{1}{{SNR}_{awgn}} = \frac{{σ}_{v 1}^{2}}{{\vert {h}_{d} \vert}^{2} {σ}_{x}^{2}} .$$

This in turn means that E{|v₁+α₁z|²<σᵥ₁²} (using (11).

It can thus be deduced that

$$\vert {v}_{1} + {α}_{1} z \vert \leq \frac{{d}_{min}}{2}$$

with probability pₑ≧10⁻⁷. Thus,

$$\frac{1}{UINR} \leq \frac{1}{{SNR}_{awgn}} \qquad ( 12 )$$

implies the occurrence of the event of correct detection described in (8) with pₑ≧10⁻⁷. Practically speaking, one may not need false detection probability as low as 10⁻⁷ and a wrong detection probability of 10⁻⁷ is good enough to train the canceller.

Having worked out the required criteria, attention can be shifted to detecting that the event has occurred. Note that a scaled copy of the impulse also occurs in the CM as described in (2). The UINR in (11) can also be written as:

$$UINR = \frac{{\vert {h}_{d} \vert}^{2} {σ}_{x}^{2}}{{\vert {v}_{1} + {α}_{1} \frac{( {y}_{c} - {v}_{2} )}{{α}_{2}} \vert}^{2}} \qquad ( 13 )$$

Note that to calculate the UINR value given by the previous equation, it is necessary to know noise samples v₁ and v₂ which obviously is not possible. Embodiments of the invention thus introduce a new function, UINR′ defined by the following:

$${UINR}^{′} = \frac{{\vert {h}_{d} \vert}^{2} {σ}_{x}^{2}}{{\vert {α}_{1} \frac{( {y}_{c} )}{{α}_{2}} \vert}^{2}} \qquad ( 14 )$$

To compensate for the impact of not considering the values of the noise samples, the condition for the correct detection given in (12) is changed to

$$\frac{1}{{UINR}^{′}} \leq \frac{1}{{SNR}_{awgn} Ϛ} \qquad ( 15 )$$

where, ζ is the extra “room” needed for correct detection in the absence of v₁ and v₂ values. The previous equation can be rephrased as

$$10 {log}_{10} ( \frac{{\vert {h}_{d} \vert}^{2} {σ}_{x}^{2}}{{\vert {y}_{c} \frac{{α}_{1}}{{α}_{2}} \vert}^{2}} ) \geq {SNR}_{awgn \vert dB} + {Ϛ}_{dB} \qquad ( 16 )$$

Practically, since the impulse noise in DM and CM has a higher power than v₁ and v₂, is very close to 1 (that is 0 dB).

However, the evaluation of UINR′ at every instance still requires knowledge of α₁/α₂. This factor is now estimated. For example, first substitute the estimated value of β from (7) in the required condition in (16), which means that a possible estimate of the β can be obtained from an MOE based estimate to initialize the selective training algorithm. This yields

$$10 {log}_{10} ( \frac{{\vert {h}_{d} \vert}^{2} {σ}_{x}^{2}}{{\vert {y}_{c} \frac{β}{η} \vert}^{2}} ) \geq {SNR}_{awgn \vert dB} + {Ϛ}_{dB} \qquad ( 17 )$$

This results in the following inequality:

$$10 {log}_{10} ( \frac{{\vert {h}_{d} \vert}^{2} {σ}_{x}^{2}}{{\vert {y}_{c} \vert}^{2} {\vert β \vert}^{2}} ) \geq {SNR}_{awgn \vert dB} + {Ϛ}_{dB} - {η}_{dB} \qquad ( 18 )$$

Again, η in the previous equation is close to 0 dB. Suppose there is an initial estimate of the β]denoted as βᵢₙ. One can use this estimate to trigger the inequality given in (18) to collect feasible samples for training using an MMSE estimate of the canceller. To relax the probability of error below 10⁻⁷ for correct detection, one can subtract another constant λ from the inequality. For 10⁻³, the value of λ is around 0 dB (for zero margin and coding gain). Thus, the final criteria for a symbol to be selected for training can be written as

$$10 {log}_{10} ( \frac{{\vert {h}_{d} \vert}^{2} {σ}_{x}^{2}}{{\vert {y}_{c} \vert}^{2} {\vert {β}_{in} \vert}^{2}} ) \geq {SNR}_{awgn \vert dB} - {λ}_{dB} + {Ϛ}_{dB} - {η}_{dB} = Γ \qquad ( 19 )$$

Where for example,

βᵢₙ=|Σₜ₌₁^{t=T}y_{c}²[t]|⁻¹Σₜ₌₁^{t=T}y_{d}[t]y_{c}[t] (20)

Note that other initial estimates of the βᵢₙ are possible, such as an a priori knowledge of the modulus of the coupling transfer function of CM to DM of the channel.

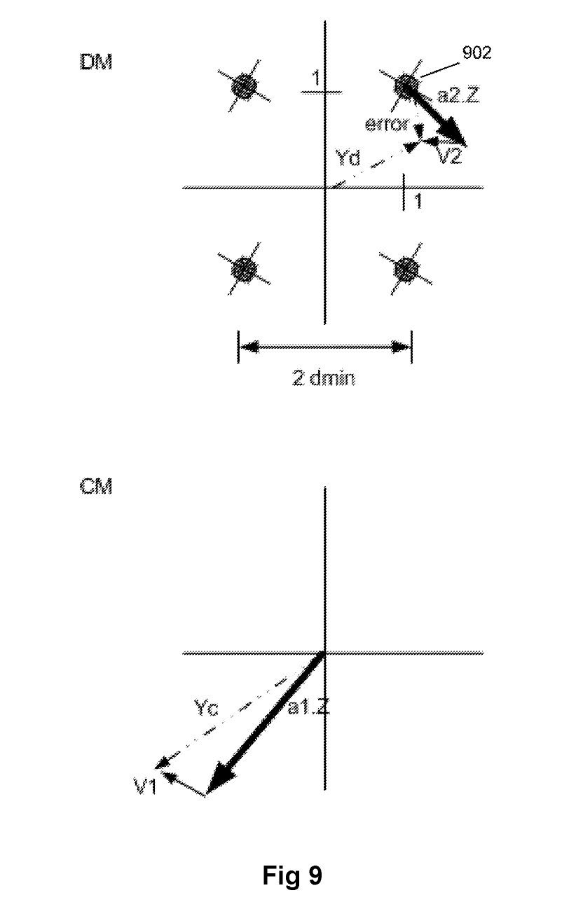

To better understand the criteria applied in (19), and as an alternative to referring to the instantaneous impulse power to the useful signal power Ratio UINR metric to determine the condition for the selection of which symbol to consider for the canceller update, one can refer to FIG. 9. FIG. 9 shows on the CM sensor output at a given tone q the displacement of α₁|z to which is superimposed a background noise component v₁. Correspondingly, on the DM sensor, the 4-QAM constellation points with background noise are visible, together with the displaced constellation point 902 due to the projection α₁. z of the impulse noise and background noise v₂, which together constitute Yd for the given symbol received under impulse noise influence. As long as the displacement distance of the transmitted constellation point is smaller than the minimum distance dmin, the sliced error by slicing Yd to the nearest constellation point is correct and can be used reliably in the training process of the canceller using MMSE based on slicer error.

Condition (19) can therefore be expressed as: as long as the projected instantaneous power of the impulse noise in DM obtained by multiplying the power of the CM FFT output sample Yc by the square of the modulus of the projected β estimate is less than the square of the minimum distance between constellation points dmin with a certain margin factor, then the conditions will be satisfied to ensure that no decoding error of the useful constellation point occurs. As a result, the slicer error can be used reliably for the training process of the canceller using MMSE based on slicer error.

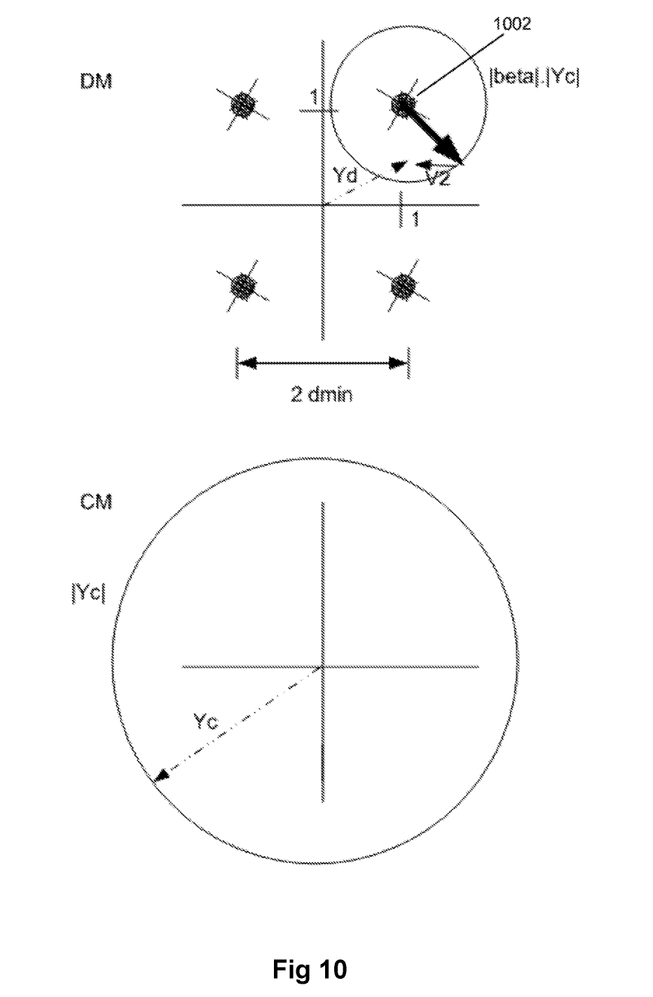

An alternative formulation of the condition is further illustrated on FIG. 10, in which the projection of Yc on the DM constellation point 1002 with the knowledge of the modulus of the estimate Beta and the modulus of the FFT output Yc in CM ensure that no decision error will result with high probability regardless of the transmitted constellation point and the additive background noise v₂.

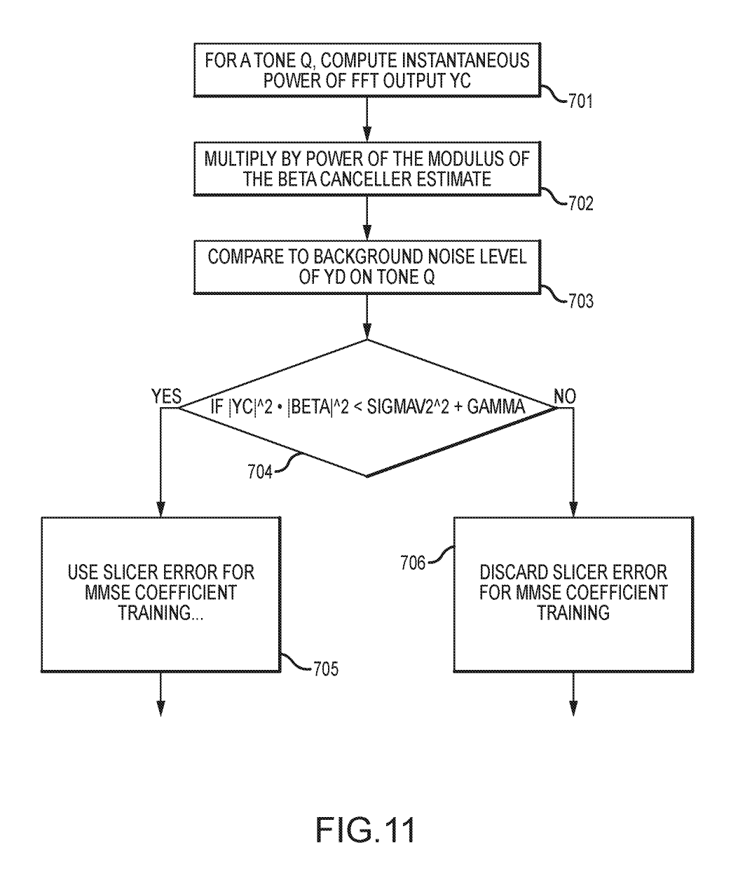

These alternative formulations to equation (19) suggest a following practical selection process in a particular embodiment of the invention, as shown in FIG. 11.

In step 701, determine the noise level of instantaneous power |y_{c}|² on the CM sensor Yc output. In step 702, multiply the instantaneous noise power by an estimate of the square modulus of the estimate β (e.g. 30 dB). In step 703, compare this product to the background noise level σᵥ₂² in DM. If the product is less than the background noise level by a margin γ (equivalent to all the terms to the right of SNRawgn in Eq. 19), as determined in step 704, the slicer error can be used for MMSE coefficient training (i.e. for updating β), as shown in step 705. Otherwise, discard the slicer error in step 706.

Using this process, for example, given a background noise level of −140 dBm/Hz σᵥ₂² in DM; and given an estimate of the square modulus of the estimate β (e.g. 30 dB), then any noise level of instantaneous power |y_{c}|² on the CM sensor Yc output less than −110 dBm/Hz would project itself on the DM sensor without introducing decoding error with high probability and therefore could be used for the selective training.

Alternatively, the selection process criteria can make use of the knowledge of Yc (not just the modulus of Y c, but also its phase) and an estimate of β (not just its modulus but also its phase) in order to determine whether the projection of (βYc) on the differential mode constellation point would exceed dmin in either the real or imaginary part with a given margin. This criteria also suffices to ensure that the transmitted constellation point will be sliced correctly thereby producing a reliable slicer error for the MMSE update.

These alternative criteria to (19) are alternative embodiments of the selected training applied to the slicer based MMSE training optimization.

The following algorithm below is an example algorithm for performing REIN cancellation starting with the initial estimate βᵢₙ using the selective training process described above. It should be noted that this algorithm can also be applied to other types of impulsive noise or even continuous noise, as long as the noise is present sufficient long during the initialization and iterative process.

Perform Initialization over T (generally 1000) symbols using (6)

1. Compute Σₜ₌₁^{t=T}y_{c}²[t], t is the time index.

2. Compute Σₜ₌₁^{t=T}y_{d}[t]y_{c}*[t], t is the time index.

3. Compute βᵢₙ=|Σₜ₌₁^{t=T}y_{c}²[t]|⁻¹Σₜ₌₁^{t=T}y_{d}[t]y_{c}*[t]

Perform Selective Training Algorithm

4. Set β[0]=0 or β[0]=βᵢₙ

5. Calculate Γ using (19)

6. While at every symbol instance

7. If UINR′>Γ then

8. e=y_{d}−h\hat{x}

9. β[i+1]=β[i]−μe

End if

End while

It should be noted that the value of μ in the above algorithm refers to the step size in the LMS adaptive training process that is exemplified in this algorithm. Other training is possible such as a block estimate.

Selective Training based on UINR for FFT output based MMSE estimation

As illustrated in FIG. 7, in order to resolve equation (6) and derive an accurate estimate of β using an FFT output based MMSE estimation process or MOE, a large number of symbols is required whenever the UINR is high; i.e. whenever the instantaneous impulse noise power is low compared to that of the useful signal.

In order to speed up the convergence of the MOE training, a selective training comparable to the one described for the MMSE training based on the slicer error can be devised. In this scenario, and in order to ensure UINR favorable that ensures a fast convergence of an FFT output based MMSE canceller estimation, the criteria to apply for the selection of which impulse to consider for the training is complementary to the one used for the Slicer error based MMSE: low UINR impulse impacted symbols are favorable for convergence.

According to one formulation, this is expressed as follows:

$$10 {log}_{10} ( \frac{{\vert {h}_{d} \vert}^{2} {σ}_{x}^{2}}{{\vert {y}_{c} \vert}^{2} {\vert {β}_{in} \vert}^{2}} ) < {Γ}^{′} \qquad ( 21 )$$

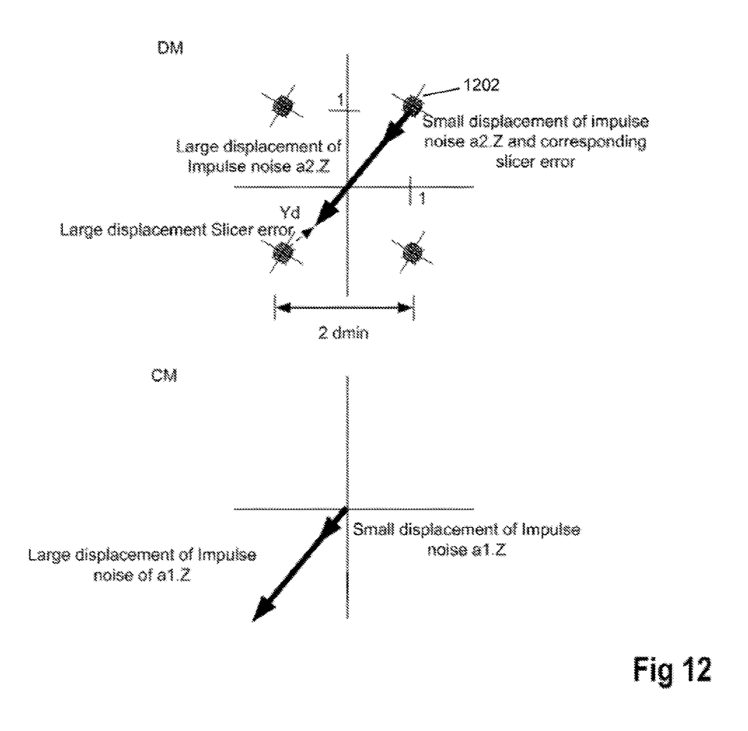

Referring to Table 1 for a 4 QAM constellation point, Γ is less than 10 dB. FIG. 12 shows on the CM sensor output at a given tone q the displacement of an impulse α₁. z of small and large amplitude. Correspondingly, on the DM sensor the 4 QAM constellation points with background noise are visible, together with a displaced constellation point due to the projection α₁. z of the impulse noise for a given symbol received under the corresponding small and large impulse noise influence. As long as the displacement distance of the transmitted constellation point is smaller than the minimum distance dmin, the sliced error by slicing Yd to the nearest constellation point is correct and can be used reliably in the training process of the canceller using MMSE based on slicer error. This is the case for the small displacement impulse. For the large displacement impulse, the slicer error is no longer reliable, as the sliced constellation point does not correspond to the transmit constellation point, leading to an unreliable slicer error. However, in this scenario the magnitude of the impulse displacement is such that correlation of the FFT output of DM and CM, according to an FFT output based MMSE estimation process, would ensure rapid convergence.

Condition (21) can therefore be alternatively expressed as: as long as the projected instantaneous power of the impulse noise in DM obtained by multiplying the power of the CM FFT output sample by the square of the module of the projected β estimate is larger or comparable to the constellation power with a certain margin factor, the conditions will be satisfied to ensure a proper convergence of the FFT output based MMSE estimation process.

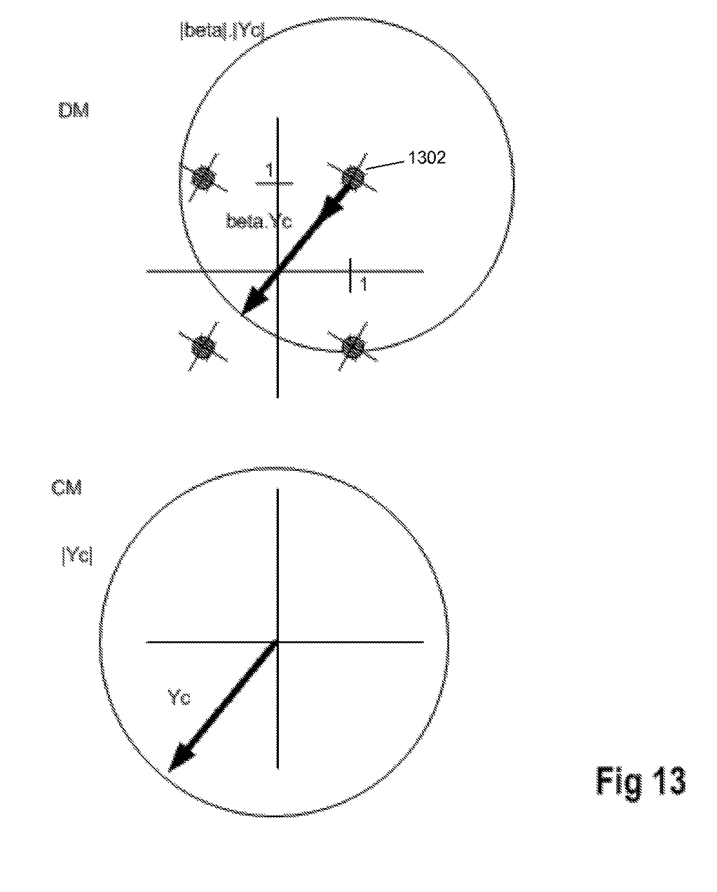

This alternative formulation of the condition is illustrated on FIG. 13, in which the projection of Yc on the DM constellation point 1302 with the knowledge of the modulus of the estimate β and the modulus of the FFT output Yc in CM ensures that regardless of the transmitted constellation point and the additive background noise v₂, the correlation process based on the FFT output data will yield satisfactory results.

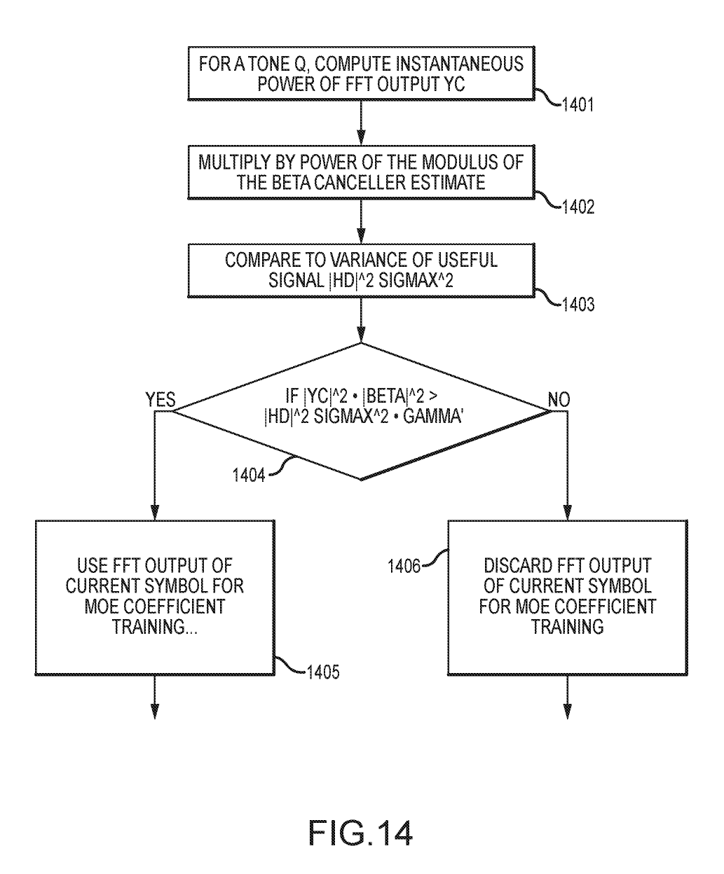

An example of using this criteria for the selection process associated with an MOE/FFT output based MMSE training in a particular embodiment of the invention is illustrated in FIG. 14.

As shown in FIG. 14, in step 1401, first determine the noise level of instantaneous power |y_{c}|² on the CM sensor Yc output. In step 1402, multiply the instantaneous noise power by an estimate of the square modulus of the estimate β (e.g. 30 dB). Compare this product to the variance of the useful signal |h_{d}|²×σᵥ₂² in DM. If the product is less than the variance of the useful signal by a margin γ (described above), as determined in step 1404, the FFT output for the current symbol can be used for MOE coefficient training (i.e. updating β), as shown in step 1405. Otherwise, discard the FFT output in step 1406.

This formulation suggests the following practical criteria for the selection process associated with an MOE/FFT output based MMSE training in a particular embodiment of the invention: Given a useful signal level of −120 dBm/Hz in DM at a given tone; and given an estimate of the square modulus of the β estimate (e.g. 30 dB) at that tone, any noise level of instantaneous power on the CM sensor Yc at that tone more than −100 dBm/Hz would project itself on the DM sensor and reduce to 10 dB the UINR in DM, thereby providing conditions for a successful selective training that ensures convergence of the MOE algorithm on that tone.

This alternative criteria to (21) constitutes an alternative embodiment of the selected training applied to the FFT output based MMSE I MOE training optimization.

Slicer error based MMSE tracking/update of the Canceller

The formulation of the selective training applied to the slicer error based MMSE canceller consisted in determining which symbols to consider for the training based on the projection of the impulse or its instantaneous power against the DM constellation grid with an initial estimate of β, as per equation (19). Note that equation (19) does not assume that the canceller is enabled (i.e. that the Per Tone Canceller block 604 and the per Tone Adder block 608 of FIG. 6 are actually used to filter impulse CM noise and combine it with the DM useful signal). Instead, only the Per Tone Canceller Coefficient Update Block 606 may be enabled to derive what could be an initial estimate of the canceller without actually performing the cancellation process. Whenever the canceller is enabled (i.e. that the Per Tone Canceller block 604 and the per Tone Adder block 608 of FIG. 6 are actually used to filter impulse CM noise and combine it with the DM useful signal), the condition of equation (19) can be further relaxed, since the slicer error at the output of the combiner becomes more and more reliable as the β estimate approaches the true coupling of the impulse noise between CM and DM (Cfr. equation 7). As a result, larger and larger impulse noise instances can be considered in the slicer based MMSE adaptation process as their partial cancellation due to the correct estimate of the channel coupling ensures reliable slicer error terms. This situation ultimately allows for a continuous tracking of the canceller coefficients update based solely on the slicer error update regardless of the amplitude of the projection of the impulse in CM, since its projection in DM will be partially cancelled.

FFT output based MMSE tracking/update of the Canceller

In a similar situation as Slicer error based MMSE tracking/update of the Canceller, equation (21) for the MOE training does not assume that the canceller is enabled (i.e. that the Per Tone Canceller 604 block and the per Tone Adder block 608 of FIG. 6 are actually used to filter impulse CM noise and combine it with the DM useful signal). Instead, only the Per Tone Canceller Coefficient Update Block 606 may be enabled to derive what could be an initial estimate of the canceller without actually performing the cancellation process. Whenever the canceller is enabled (i.e. that the Per Tone Canceller block 604 and the per Tone Adder block 608 of FIG. 6 are actually used to filter impulse CM noise and combine it with the DM useful signal), the condition of equation (21) can be further relaxed, since the exact determination of which constellation point was transmitted becomes more reliable. In this scenario, the knowledge of which constellation point was transmitted could be put leveraged in order to relax the condition (21) or ensure faster convergence. This aspect will now illustrated in more detail below.

As an extrapolation of the 4-QAM case presented on FIG. 7 to a multilevel QAM modulation scheme, MOE is expected to converge to the bound reasonably fast, whenever the ensemble of symbols on which the adaptation is done is such that the power of the Useful Signal over the (Instantaneous) power of the Impulse Signal is below 10 dB. For a 4-QAM modulated signal, the power is constant regardless of which constellation point is transmitted. However, for a multilevel QAM modulation scheme, the instantaneous power varies symbol after symbol based on which point of the constellation is transmitted.

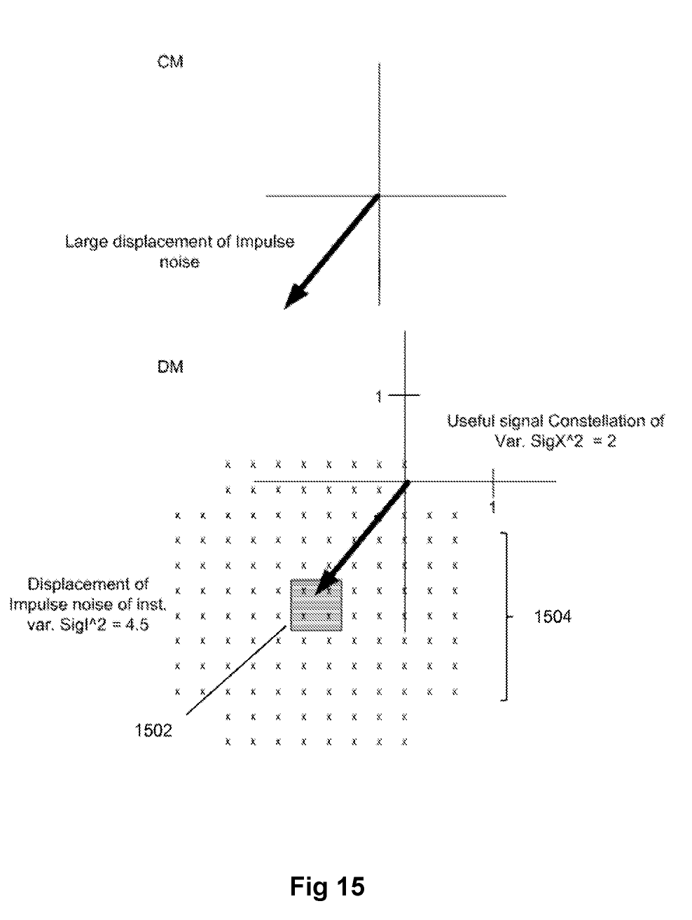

Since what matters is a ratio of instantaneous power on the ensemble of symbols on which the MOE adaptation symbols, we can conclude that desirable symbols are those that are either subject to a large impulse hits (as seen by a large instantaneous power of the signal measured in CM) or that are transmitted with low signal power, such as if the transmitted constellation point was close to the axis origin, as illustrated in FIG. 15, by the shaded region 1502. FIG. 15 represents a QAM-7 constellation 1504 displaced by a large impulse noise. For a large constellation such as a QAM 14, the ratio of power of the outermost point of the constellation to the power of the inner point of the constellation may be as high as 42 dB. This constitutes a wide swing of instantaneous transmit signal power to be compared to the instantaneous power of the projected impulse noise.

A possible selective training algorithm for MOE would therefore consist in selecting those symbols that are transmitted with low energy (the lowest point in the constellation) and/or affected by a large CM noise level. It is for those symbols that the (instantaneous) power of the Useful Signal over the (Instantaneous) power of the Impulse Signal or UINR is the most favorable for a fast convergence of an FFT output based MMSE/MOE adaptation.

The selective training algorithm in these embodiments consists in selecting for MOE training only those points of lowest variance of useful signal whenever an initial estimate of the canceller has been applied, which ensures a somewhat accurate detection of the smallest transmitted constellation point and some assurance that the transmitted constellation points originate from a region close to the axis, as illustrated by the shaded region 1502 in FIG. 15. This selective training can be achieved by looking at the DM FFT output before or after canceller, in which case, as for the selective training for MMSE, while the canceller is being trained to its optimum value, the selection process needs to be adjusted as the displacement of the constellation point by the impulse is reduced given the fact that the canceller effectively (or partially) cancels the impulse. By restricting the selective training to the lowest transmitted constellation points, convergence of the MOE is ensured. However, the smaller the decision region, the lower the probability of having transmitted constellation points that fall in this region in the first place, thereby impacting the convergence rate as well. This situation ultimately allows for a continuous tracking of the canceller coefficients update based solely on the FFT output data regardless of the amplitude of the projection of the impulse in CM, as long as the projection of the impulse in DM is higher or commensurate with the power of the constellation point transmitted.

The condition for the selection of the symbol to update the canceller (21) is adapted to reflect that the instantaneous power of the received signal after cancellation is used in the decision as opposed to its variance across whole symbols, as follows:

$$10 {log}_{10} ( \frac{{\vert {h}_{d} \vert}^{2} \vert {x}^{2} \vert}{{\vert {y}_{c} \vert}^{2} {\vert {β}_{in} \vert}^{2}} ) < {Γ}^{′} \qquad ( 22 )$$

The selection process in this example embodiment therefore determines that a given symbol is worthy of being considered for an update/tracking of the MOE based canceller whenever the projected power of the impulse noise on the DM channel exceeds by a certain given margin the instantaneous power of the estimated transmit constellation point.

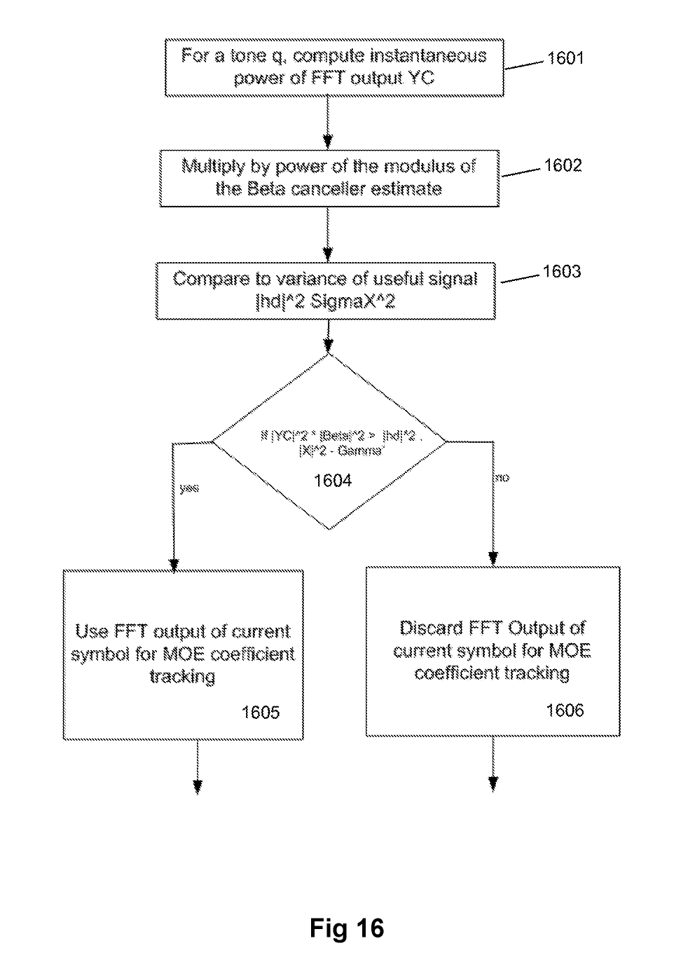

A flowchart for an example selection process applied to MOE in tracking mode is depicted on FIG. 16. As shown in FIG. 16, in step 1601, first determine the noise level of instantaneous power |y_{c}|² on the CM sensor Yc output. In step 1602, multiply the instantaneous noise power by an estimate of the square modulus of the estimate β (e.g.30 dB). Compare this product to the variance of the useful signal across whole symbols |h_{d}|²×x² in DM. If the product is less than the variance of the useful signal by a margin γ (described above), as determined in step 1604, the FFT output for the current symbol can be used for MOE coefficient training (i.e. updating β), as shown in step 1605. Otherwise, discard the FFT output in step 1606.

Complementary of MOE (MMSE FFT based) and MMSE slicer based solutions

As shown in the discussion earlier, convergence of MOE vs. MMSE is ensured in opposite conditions of UINR. As a result, MOE and MMSE should be considered complementary and not exclusive: i.e. MOE can be used to ensure initial estimate of a CM to DM coupling in the iterative selective process using a MMSE selective training process, as proposed in the algorithm described above. Alternatively, in order to speed up convergence time, all symbols affected by impulses could ultimately be used simultaneously in the update/training/tracking of the canceller: if UINR is high on a particular symbol, this symbol is used in a MMSE selective training process, while if the UINR is low on another particular symbol, this symbol is used in a MOE selective training process.

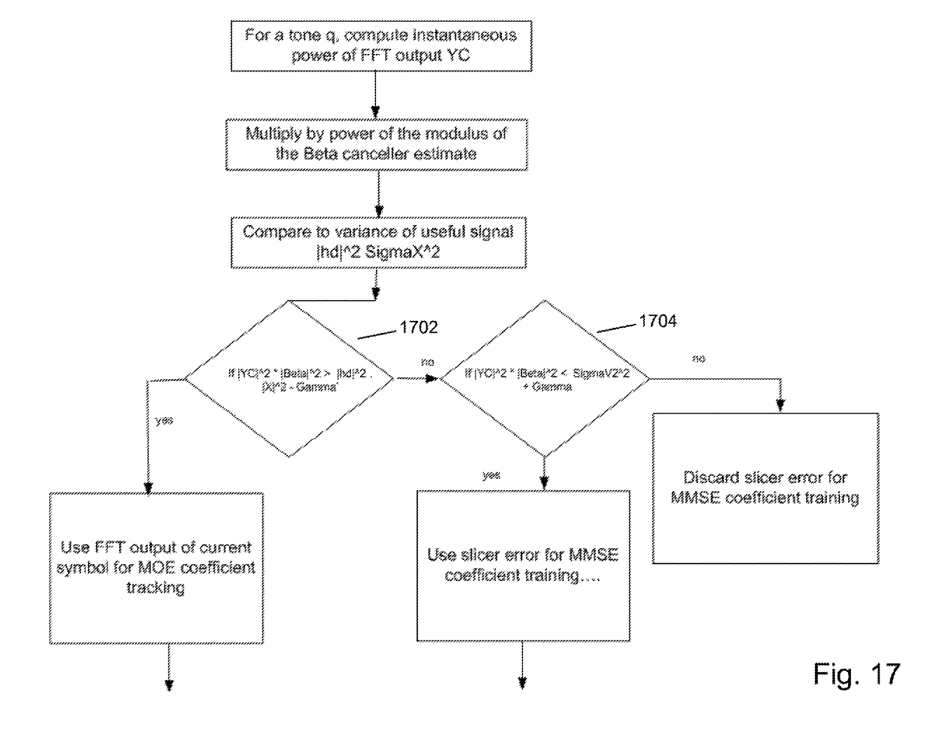

This duality of the selective training is represented in FIG. 17. FIG. 17 shows an embodiment in which the selective training consists in testing first whether the impulse detected symbol can be used for MOE tracking in step 1702 (as described above in connection with FIG. 11), and if not, further determining in step 1704 whether it can be used for MMSE coefficient training based on the projection of the impulse power and that of the useful signal power (as described above in connection with FIG. 4). Other combinations of selective training conditions can be devised based on combinations of flowcharts depicted in diagrams FIG. 11 and FIG. 4 which can be combined as an alternative embodiment.

As a particular embodiment of the canceller coefficient update scheme, the selective training process considered for MOE (MMSE FFT based) and MMSE slicer based solutions can be applied to a symbol based adaptation scheme such as an LMS, or to a block of symbol adaptation scheme, wherein the canceller is computed based on an ensemble of selected training symbols before being applied. An alternative embodiment may consist in deriving a block of symbols estimate followed by a per symbol estimate.

Selective training, conditional cancelling, selection criteria

The above described embodiments of the impulse canceller scheme generally make use of a selective training for the update and training of the canceller. However, a conditional application of the canceller can also be implemented in an alternative embodiment of the invention. In this case, the conditional application of the canceller relates to a decision process that determines whether the canceller is enabled for particular symbols (i.e. that the Per Tone Canceller block 604 and the per Tone Adder block 608 of FIG. 6 are actually used to filter impulse CM noise and combine it with the DM useful signal). This decision can be based on a variety of criteria applied to the one and/or the other sensor.

As an example, given the difficulty in estimating the canceller coefficient on symbols with high levels of impulse noise, a selection process of which symbols are used for the estimate of the Covariance matrix is proposed that enables computation in the event of noise having lower amplitude. This process is another type of selective training process.

In parallel to the selection process for the purpose of selective training, a selection of which symbols on which to perform the cancellation is proposed. Such conditional cancelling is targeted for intermittent noises, in which cancelling is only applied whenever impulse noise is detected, or whenever Impulse to Noise Ratio on the second sensor is determined to be below a given threshold to be of value for the process of cancellation. For example, if the canceller is applied throughout the full period of a 120 Hz REIN noise, the noise which is only affected by impulse for a few DMT symbol out of the 120 Hz period, the canceller and combiner output may increase the level of DM background noise during the non-impulse impacted symbols due to the fact that Impulse to Background Noise ratio (INR) in the CM sensor is less than the corresponding INR on the DM sensor. As a rule of thumb, if the canceller is trained over impulsive symbols and applied on non-impulsive symbols, folding of CM noise is avoided if INR CM is more than 10 dB above the INR in DM.

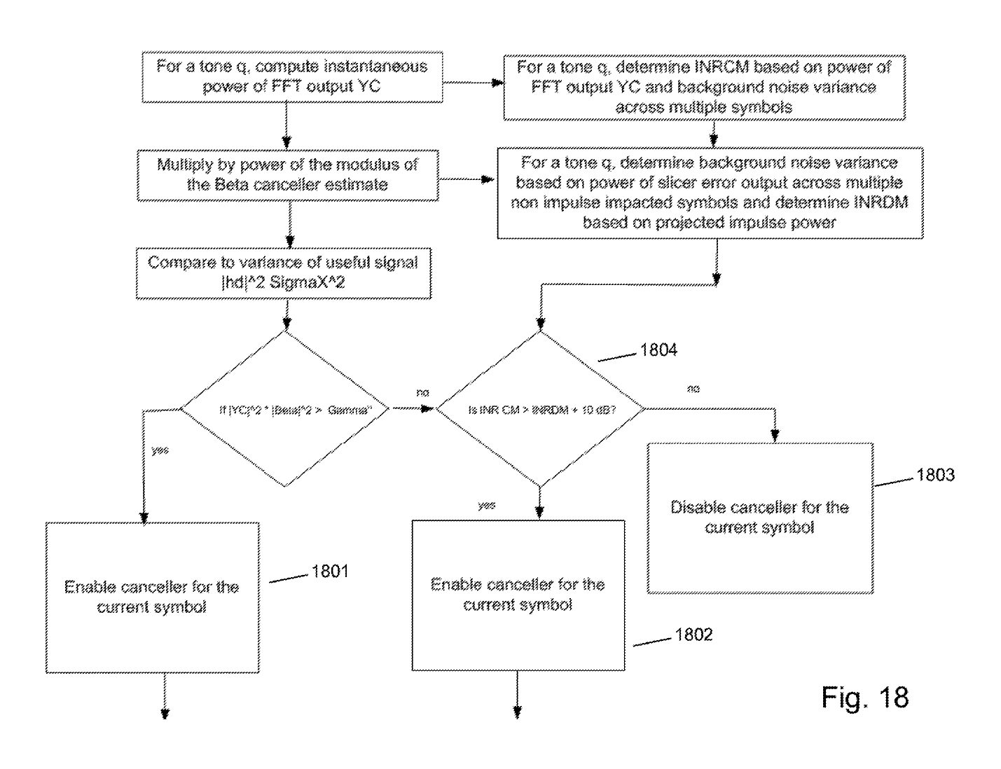

FIG. 18 illustrates another embodiment of the invention in which the selection process embellishes the selection process described in connection with FIG. 16 by determining whether or not the canceller is enabled for a given symbol, as shown in steps 1801, 1802 and 1803. The decision logic to enable the canceller in this embodiment further checks for a projected power of impulse noise exceeding a certain threshold for an impulse impacted symbol and whether the computed INRCM exceeds by 10 dB the computed INRDM for non-impulse impacted symbols, as determined in step 1804. Accordingly, the decision is made to enable the canceller or not for the current symbol.

In alternative embodiments of the invention, both processes of selection of symbols for selective training and for conditional application of the canceller can be based on various criteria, other than those embodied by equation (19) and (21) and their variations: criteria can be characteristics of the impulse noise burst (power, duration, etc.), origin of the noise (in case of multiple distinguishable noise sources), levels of INR on sensors, as illustrated in FIG. 18. The particular selection criteria is meant for example to train and/or adapt, and/or apply the canceller or not on symbols that are affected by signals with desirable characteristics. The selection criteria is derived on a per tone basis, a group of contiguous or non-contiguous tones, on a per band basis or over the whole band.

The detection of the impulse noises to be selected for training and/or cancelling can be done on the primary sensor alone, second sensor or, with primary and second sensor together. The sensing through a common mode sensor ensures in general that even if there is presence of leaked useful signal, the impulse noise is expected to be of greater variance than the background noise and/or leaked useful signal.

Finally, the term impulse noise should be covering all types of noise that are not continuous in nature, such as intermittent noises that may last for a certain amount of time.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for wireless communication, comprising:
combining per-tone frequency information from a first sensor and a second sensor;
detecting impulse noise based at least in part on the combined per-tone frequency information; and
selectively training an impulse noise canceller while in a data transmission mode based at least in part on an amount of the detected impulse noise.

2. The method of claim 1, further comprising:
canceling impulse noise affecting a received data signal based at least in part on the selective training of the impulse noise canceller.

3. The method of claim 1, further comprising:
selecting a process for training based at least in part on a ratio of a useful signal power to an instantaneous total noise power; and
training the impulse noise canceller while in the data transmission mode based at least in part on the selected process.

4. The method of claim 3, wherein the process is based at least in part on a minimizing mean square error (MMSE) computed using fast Fourier transform (FFT) outputs corresponding to the combined per-tone frequency information.

5. The method of claim 1, wherein selectively training an impulse noise canceller further comprises:
training a coefficient of an impulse noise canceller for different portions of a duration of the impulse noise.

6. The method of claim 5, further comprising:
determining the portions based at least in part on at least one from the group consisting of: a Useful Signal Power to Instantaneous Noise Power ratio (UINR); a projected instantaneous power of the impulse noise; and a product of a modulus of a sensor signal obtained at a FFT output and a modulus of an estimate of the coefficient.

7. The method of claim 1, wherein selectively training the impulse noise canceller comprises:
selectively training the impulse noise canceller based at least in part on a slicer error.

8. The method of claim 1, further comprising:
receiving a data signal comprising a plurality of tones; and
cancelling, by the impulse noise canceller, noise on each of the plurality of tones independently.

9. The method of claim 1, further comprising:
receiving, by the first sensor, a differential mode data signal; and
receiving, by the second sensor, a common mode signal corresponding to the differential mode data signal.

10. The method of claim 1, wherein the first sensor is coupled to a twisted pair line of the wire line communication system and the second sensor is coupled to an unused twisted pair line of the wireline communication system.

11. An apparatus for wireless communication, comprising:
means for combining per-tone frequency information from a first sensor and a second sensor;
means for detecting impulse noise based at least in part on the combined per-tone frequency information; and
means for selectively training an impulse noise canceller while in a data transmission mode based at least in part on an amount of the detected impulse noise.

12. A communication device, comprising:
a processor;
memory in electronic communication with the processor; and
instructions stored in the memory and operable, when executed by the processor, to cause the communication device to:
combine per-tone frequency information from a first sensor and a second sensor;
detect impulse noise based at least in part on the combined per-tone frequency information; and
selectively train an impulse noise canceller while in a data transmission mode based at least in part on an amount of the detected impulse noise.

13. The communication device of claim 12, wherein the instructions are further executable by the processor to cause the communication device to:
cancel impulse noise affecting a received data signal based at least in part on the selective training of the impulse noise canceller.

14. The communication device of claim 12, wherein the instructions are further executable by the processor to cause the communication device to:
select a process for training based at least in part on a ratio of a useful signal power to an instantaneous total noise power; and
train the impulse noise canceller while in the data transmission mode based at least in part on the selected process.

15. The communication device of claim 14, wherein the process is based at least in part on a minimizing mean square error (MMSE) computed using fast Fourier transform (FFT) outputs corresponding to the combined per-tone frequency information.

16. The communication device of claim 12, wherein the instructions executable by the processor to cause the communication device to selectively train an impulse noise canceller further comprise instructions executable by the processor to cause the communication device to:
train a coefficient of an impulse noise canceller for different portions of a duration of the impulse noise.

17. The communication device of claim 16, wherein the instructions are further executable by the processor to cause the communication device to:
determine the portions based at least in part on at least one from the group consisting of: a Useful Signal Power to Instantaneous Noise Power ratio (UINR); a projected instantaneous power of the impulse noise; and a product of a modulus of a sensor signal obtained at a FFT output and a modulus of an estimate of the coefficient.

18. The communication device of claim 12, wherein the impulse noise canceller is trained based at least in part on a slicer error.

19. The communication device of claim 12, wherein the instructions are further executable by the processor to cause the communication device to:
receive a data signal comprising a plurality of tones, and cancelling, by the impulse noise canceller, noise on each of the plurality of tones independently.

20. The communication device of claim 12, wherein the instructions are further executable by the processor to cause the communication device to:
receive, by the first sensor, a differential mode data signal; and
receive, by the second sensor, a common mode signal corresponding to the differential mode data signal.

21. The communication device of claim 12, wherein
the first sensor is coupled to a twisted pair line of the wire line communication system and the second sensor is coupled to an unused twisted pair line of the wireline communication system.

22. A non-transitory computer readable medium storing code for wireless communication, the code comprising instructions executable by a processor to cause a communication device to:
combine per-tone frequency information from a first sensor and a second sensor;
detect impulse noise based at least in part on the combined per-tone frequency information; and
selectively train an impulse noise canceller while in a data transmission mode based at least in part on an amount of the detected impulse noise.

23. The non-transitory computer-readable medium of claim 22, wherein the instructions are further executable by the processor to cause the communication device to:
cancel impulse noise affecting a received data signal based at least in part on the selective training of the impulse noise canceller.

24. The non-transitory computer-readable medium of claim 22, wherein the instructions are further executable by the processor to cause the communication device to:
select a process for training based at least in part on a ratio of a useful signal power to an instantaneous total noise power; and
train the impulse noise canceller while in the data transmission mode based at least in part on the selected process.

25. The non-transitory computer-readable medium of claim 24, wherein the process is based at least in part on a minimizing mean square error (MMSE) computed using fast Fourier transform (FFT) outputs corresponding to the combined per-tone frequency information.

26. The non-transitory computer-readable medium of claim 22, wherein the instructions executable by the processor to cause the communication device to selectively train an impulse noise canceller further comprise instructions to:
train a coefficient of an impulse noise canceller for different portions of a duration of the impulse noise.

27. The non-transitory computer-readable medium of claim 26, wherein the instructions are further executable by the processor to cause the communication device to:
determine the portions based at least in part on at least one from the group consisting of: a Useful Signal Power to Instantaneous Noise Power ratio (UINR); a projected instantaneous power of the impulse noise; and a product of a modulus of a sensor signal obtained at a FFT output and a modulus of an estimate of the coefficient.

28. The non-transitory computer-readable medium of claim 22, wherein the impulse noise canceller comprises: selectively training the impulse noise canceller based at least in part on a slicer error.

29. The non-transitory computer-readable medium of claim 22, wherein the instructions are further executable by the processor to cause the communication device to:
receive a data signal comprising a plurality of tones, and cancelling, by the impulse noise canceller, noise on each of the plurality of tones independently.

30. The non-transitory computer-readable medium of claim 22, wherein the instructions are further executable by the processor to cause the communication device to:
receive, by the first sensor, a differential mode data signal; and
receive, by the second sensor, a common mode signal corresponding to the differential mode data signal.
